(19) United States
(12) Patent Application Publication
(10) Pub. No.: US 2017/0146176 A1
(43) Pub. Date: May 25, 2017

(54) Automated nitrogen charging system

(71) Applicants: Justin P. Manley, Murphy, TX (US); William Garfield, Macungie, PA (US)

(72) Inventors: Justin P. Manley, Murphy, TX (US); William Garfield, Macungie, PA (US)

(21) Appl. No.: 14/949,912

(22) Filed: Nov. 24, 2015

(51) Int. Cl. F16L 55/045

(52) U.S. Cl. CPC F16L 55/045

(57) ABSTRACT

Disclosed is a control system for a pulsation dampener device. The system comprises a fluid reservoir, a pipeline assembly extending between the reservoir and the bladder of the pulsation dampener device, and a bladder sensor for gauging the fluid pressure within the bladder. The system is configured such that, when the pulsation dampener device is not operative and when the pressure of the fluid within the bladder is above or below a predetermined preoperative bladder threshold, the excess or deficient equivalent volume of fluid respectively is transferred from the bladder to the reservoir or from the reservoir to the bladder respectively. Further, when the pulsation dampener device is operative and when at least one pressure reading of the fluid within the bladder is above or below a predetermined operative bladder threshold, the excess or deficient equivalent volume of fluid respectively is transferred from the bladder to the reservoir or from the reservoir to the bladder respectively.

### BACKGROUND

### Field of the Invention

The present invention relates to pulsation dampener devices and more particularly to a control system and method of a pulsation dampener device.

The mark of an effective pulsation dampener device lies in its ability to adapt to or take in a wide range of pulsation pressures from a pipeline and deliver a smooth output. The wider is the range, the better is the pulsation dampener device. As the range widens, the pressures which act on a pulsation dampener device become more haphazard. An effective pulsation dampener device is generally known in the art to be built with tougher materials to withstand the pulsation fatigue. While being built with tougher materials covers for the lack of sensitivity and instantaneous adaptation to a degree, a smarter pulsation dampener device is the one that is highly sensitive to the sudden change in the pressures by adapting to it instantaneously. A smarter pulsation dampener device may not be required to be built of relatively tougher materials when the same is configured to be sensitive enough to adapt to the harsh conditions. For a pulsation dampener device to be so sensitive, it obviously requires a setup of supporting gadgetry to accomplish the task at hand.

### SUMMARY

An embodiment of the present invention comprises a pulsation dampener control system employed for supporting a pulsation dampener device. The system comprises a nitrogen reservoir, a positive displacement pump, and a pipeline assembly extending between the reservoir and the bladder of the pulsation dampener device via the pump. The pipeline assembly comprises an upstream and a downstream pipeline wherein, the upstream pipeline enables the flow of nitrogen from the reservoir to the bladder and whereas, the downstream pipeline enables the flow of nitrogen from the bladder to the reservoir. The upstream and downstream pipelines converge at and diverge from a couple of two-way valves, which are instrumental in ensuring the upstream and downstream flow of nitrogen. Further, an electronically-controlled reservoir solenoid valve is disposed on the upstream pipeline between the reservoir and the pump wherein, the reservoir solenoid valve facilitates the fluid transfer from the reservoir to the bladder. The system further comprises a bladder sensor for constantly gauging the pressure of nitrogen within the bladder.

The system further comprises a central database with is disposed in operative communication with a processor. The central database is divided into a pressure database and a volume database. The pressure database is listed with a predetermined bladder threshold and a threshold bracket for both preoperative and operative conditions of the pulsation dampener device wherein, a threshold value or bracket comprises either a threshold pressure value or a threshold pressure range respectively. The bladder threshold at the preoperative condition is preferably 500 psi whereas, the bladder threshold at the operative condition is a value at which the volume of the bladder is half the volume of the pulsation dampener device. Exemplarily, the value of bladder threshold at operative condition is set at 1000 psi.

The volume database is listed with “normal volume” of nitrogen within the bladder, which comprises the volume of nitrogen within the bladder at a constant pressure, which preferably is set at 1 bar. The purpose of incorporating the normal value concept is to determine the volume of nitrogen that needs to be transferred between the reservoir and the bladder.

The processor comprises a calculation module, which is disposed in communication with the volume database, for determining the volume of nitrogen to be transferred between the reservoir the bladder based on the pressure reading from the bladder sensor. The processor further comprises a comparison module, which is disposed in operative communication with the pressure database, for comparing the current pressure reading from the bladder sensor with against the corresponding bladder threshold values. The processor further comprises a difference module for performing necessary mathematical functions. The processor further comprises a power module, which is disposed in electrical communication with the pulsation dampener device, reservoir solenoid valve, pump, and the two-way valves.

The system is configured such that, at the preoperative condition of the pulsation dampener device, the comparison module constantly compares the pressure readings from the bladder sensor against the corresponding preoperative bladder threshold listed within the pressure database. In the event of the pressure reading being above or below the prescribed reservoir threshold, the system is configured such that, the difference module calculates the difference between the current pressure within the bladder and the bladder threshold.

In the event of the current pressure being lower than the preoperative bladder threshold, the deficient pressure is converted into an equivalent volume by the calculation module based on the normal volume of nitrogen within the bladder. At this point, the power module transmits a computer command to open the reservoir solenoid valve, the two way valves and another simultaneous computer command to activate the pump. This results in said reservoir solenoid valve being opened allowing the calculated volume of nitrogen in the reservoir to be pumped to the bladder through the upstream and common pipelines via the pump and the two-way valves. Once the transfer of nitrogen from the reservoir to the bladder is complete, the pressure of nitrogen within the bladder automatically reaches the prescribed bladder threshold.

In the event of the current pressure being higher than the bladder threshold, the excess amount of pressure is converted into equivalent volume by the calculation module. At this point, the power module transmits a computer command to open the reservoir solenoid valve, the two-way valves and another simultaneous computer command to activate the pump. This results in said reservoir solenoid valve being opened allowing the calculated volume of nitrogen in the bladder to be pumped to the reservoir through the downstream and common pipelines via the pump and the first and second two-way valves. Once the transfer of nitrogen from the bladder to the reservoir is complete, the pressure of nitrogen within the bladder automatically reaches the prescribed bladder threshold.

The system is configured such that, during the operational condition of the pulsation dampener device, the comparison module constantly compares the pressure readings from the bladder sensor against the corresponding operative bladder threshold listed within the pressure database. As mentioned earlier, the bladder threshold at operative condition of the pulsation dampener device is a value at which, the volume of the bladder is half the volume of the pulsation dampener device. In the event of the pressure reading being above or below the prescribed reservoir threshold, the system is configured such that, the difference module calculates the difference between the current pressure within the bladder and the bladder threshold.

In the event of the current pressure being lower than the bladder threshold, the deficient pressure is converted into equivalent volume by the calculation module. At this point, the power module transmits a computer command to open the reservoir solenoid valve, the two-way valves and another simultaneous computer command to activate the pump. This results in said reservoir solenoid valve being opened allowing the calculated volume of nitrogen in the reservoir to be pumped to the bladder through the upstream and common pipelines via the pump and the two-way valves. Once the transfer of nitrogen from the reservoir to the bladder is complete, the pressure of nitrogen within the bladder automatically reaches the prescribed bladder threshold (from the exemplary 500 psi to 1000 psi, which is 50% of the volume of the pulsation dampener device).

During the running of the pulsation dampener device, due to the increase in the intensity of the pulsation, the pipeline pressure increases causing the bladder volume to decrease below 50% of the volume of pulsation dampener device. On the other hand, as the operation of the pulsation dampener device nears a close, the pulsation pressure in the pipeline assembly decreases causing the bladder to expand beyond 50% of the volume of the pulsation dampener device.

In the event of the current pressure being lesser than the bladder threshold bracket, the deficient amount of pressure is converted into equivalent volume by the calculation module. At this point, the power module transmits a computer command to open the reservoir solenoid valve, the two way valves and another simultaneous computer command to activate the pump. This results in said reservoir solenoid valve being opened allowing the calculated volume of nitrogen in the reservoir to be pumped to the bladder through the upstream and common pipelines via the two-way valves. Once the transfer of nitrogen from the bladder to the reservoir is complete, the pressure of nitrogen within the bladder automatically falls within the bladder threshold bracket.

In the event of the current pressure being greater than the bladder threshold bracket, the excess amount of pressure is converted into equivalent volume by the calculation module. At this point, the power module transmits a computer command to open the reservoir solenoid valve, the two-way valves, and another simultaneous computer command to activate the pump. This results in said reservoir solenoid valve being opened allowing the calculated volume of nitrogen in the bladder to be pumped to the reservoir through the downstream and common pipelines via the two-way valves. Once the transfer of nitrogen from the reservoir to the bladder is complete, the pressure of nitrogen within the bladder automatically falls within the bladder threshold bracket. Notably, the purpose of incorporating the concept of bladder threshold bracket is to engage in trend monitoring, which controls overcorrection by preventing a high number of smaller amounts of adjustments.

Other objects and advantages of the embodiments herein will become readily apparent from the following detailed description taken in conjunction with the accompanying drawings.

### BRIEF DESCRIPTION OF THE DRAWINGS

FIG. 1, according to an embodiment of the present invention, is an illustration of a schematic illustration of the pulsation dampener control system incorporating both the upstream and downstream pipelines.

FIG. 2, according to an embodiment of the present invention, is an illustration of a schematic illustration of the pulsation dampener control system incorporating the upstream pipeline.

FIG. 3, according to an embodiment of the present invention, is an illustration of a schematic illustration of the pulsation dampener control system incorporating the downstream pipeline.

FIG. 4, according to an embodiment of the present invention, is a block diagram of the pulsation dampener control system.

FIG. 5, according to an embodiment of the present invention, is a flowchart mapping the series of steps taken in the event of the reservoir threshold criteria been met and not been met.

FIG. 6, according to an embodiment of the present invention, is a flowchart mapping the series of steps taken in the event of the preoperative bladder threshold criteria been met and not been met.

FIG. 7, according to an embodiment of the present invention, is a flowchart mapping the series of steps taken in the event of the operative bladder threshold criteria been met and not been met.

FIG. 8, according to an embodiment of the present invention, is a flowchart mapping the series of steps taken in the event of the bladder threshold bracket criteria been met and not been met during the running of the pulsation dampener device.

FIG. 9, according to an embodiment of the present invention, is a flowchart mapping the series of steps taken in the event of the preoperative pipeline threshold criteria been met and not been met.

### FIGURES—REFERENCE NUMERALS

10—Pulsation Dampener Control System
12—Pulsation Dampener Device
14—Nitrogen Reservoir
16—Positive Displacement Pump
16I—Pump Input
16O—Pump Output
18—Nitrogen Storage Tank
20—Storage Pipeline
22—Reservoir Manifold
24—Storage Manifold
26—Reservoir Manual Valve
28—Storage Manual Valve
30—Reservoir Sensor
32—Storage Sensor
34—Storage Solenoid Valve
36—Check Valve
36I—Input Check Valve
36O—Output Check Valve
38—Upstream Pipeline
381—First Upstream Section
382—Second Upstream Section
40—Downstream Pipeline
401—First Downstream Section
402—Second Downstream Section
42—Common Pipeline
421—First Common Pipeline
422—Second Common Pipeline
44—Reservoir Solenoid Valve
46—Two-way Valve
461—First Two-way Valve
462—Second Two-way Valve
48—Central Database
48P—Pressure Database
48V—Volume Database
50—Processor
52—Bladder Sensor
54—Pipeline Sensor
56—Calculation Module
58—Comparison Module
60—Difference Module
62—Power Module

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

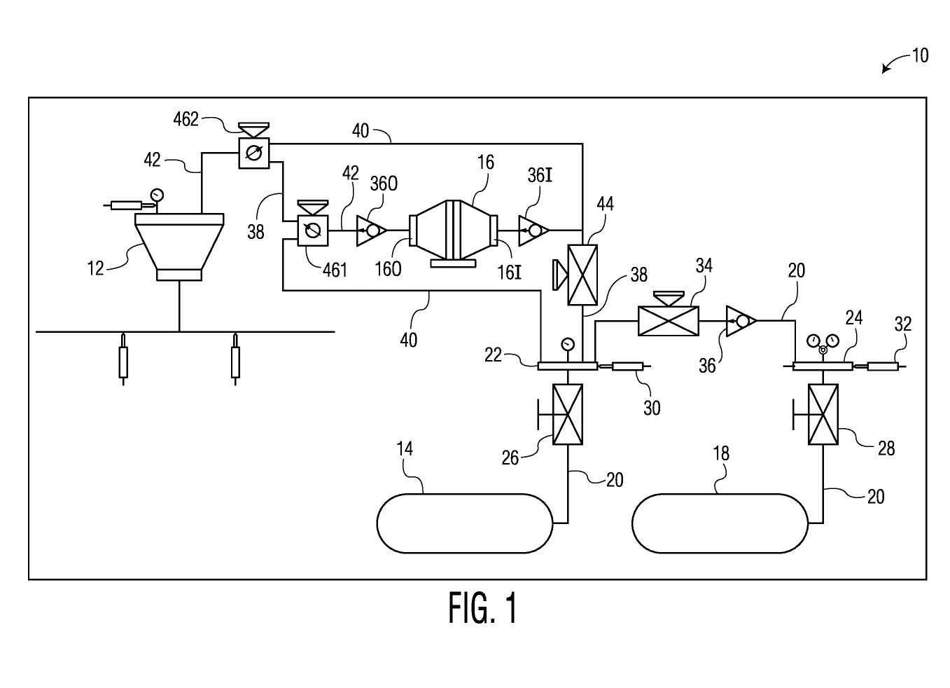

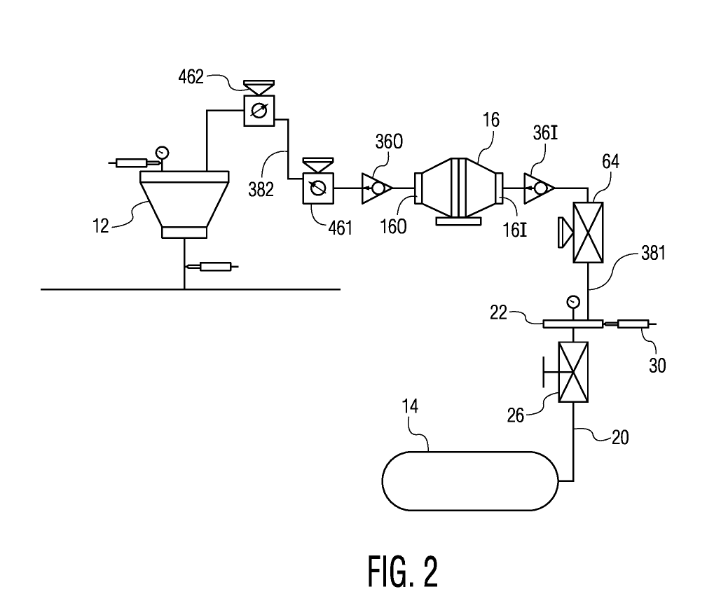

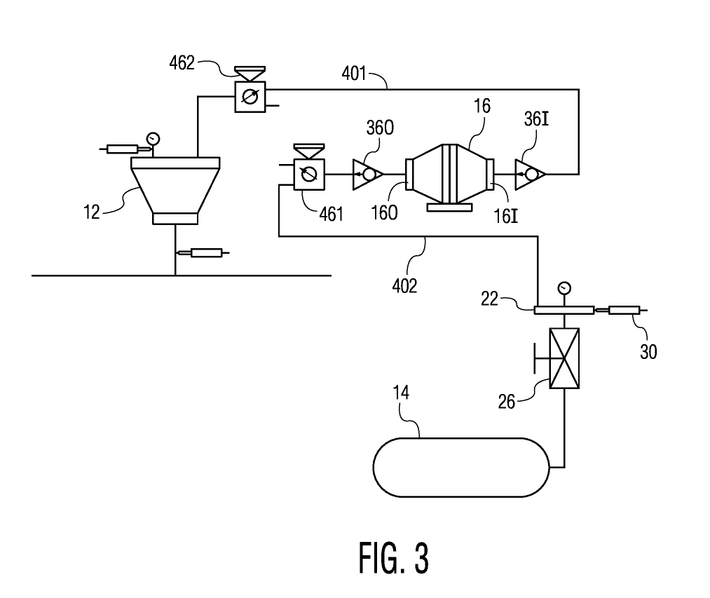

Referring to FIGS. 1 through 3, an embodiment of the present invention are directed to a pulsation dampener control system 10, which is used in conjunction with a pulsation dampener device 12. The system 10 comprises a nitrogen reservoir 14, a positive displacement pump 16, and a nitrogen storage tank 18. The system 10 of the present invention optimizes the operational effectiveness of the pulsation dampener device 12, while increasing the longevity and reliability of the bladder of the pulsation dampener device 12 and decreasing the risks to the health and safety of the environment.

Referring to FIGS. 1 through 3, the system 10 further comprises a storage pipeline 20 extending between the reservoir 14 and the storage tank 18 for facilitating fluid transfer therebetween. More particularly, sections of storage pipeline 20 proceeding from the reservoir 14 and the storage tank 18 terminate in a reservoir manifold 22 and a storage manifold 24 respectively, while the rest of the storage pipeline 20 extends between first openings of the reservoir and storage manifolds 22 and 24. Notably, two manual valves, viz., a reservoir manual valve 26 and a storage manual valve 28, are disposed on the storage pipeline 20 between the reservoir 14 and the reservoir manifold 22 and between the storage tank 18 and the storage manifold 24 respectively for manually permitting or blocking the fluid flow from the reservoir 14 and storage tank 18 respectively in the event of an emergency or the like. A reservoir sensor 30 and a storage sensor 32 extend from a second opening of each of the reservoir and storage manifolds 22 and 24 respectively so as to constantly gauge the pressure of nitrogen in both of the reservoir and storage tank 14 and 18 in real time. An electronically-controlled storage solenoid valve 34 is disposed on the storage pipeline 20 extending between the reservoir and storage manifolds 22 and 24 wherein, the storage solenoid valve 34 facilitates fluid transfer from the storage tank 18 and the reservoir 14. Further, a check valve 36 is disposed between the storage solenoid valve 34 and the storage manifold 24 so as to ensure a unidirectional flow of nitrogen from the storage tank 18 to the reservoir 14. Notably, as the pressure of the nitrogen in the storage tank 18 is always higher than that of the nitrogen in the reservoir 14, no pump is needed to facilitate the transfer of nitrogen therebetween.

Referring to FIGS. 1 through 3, the system 10 further comprises a pipeline assembly extending between the reservoir 14 and the bladder so as to enable the fluid transfer therebetween. The pipeline assembly comprises an upstream and a downstream pipeline 38 and 40 wherein, the upstream pipeline 38 enables the flow of nitrogen from the reservoir 14 to the bladder and whereas, the downstream pipeline 40 enables the flow of nitrogen from the bladder to the reservoir 14. Notably, in the pipeline assembly, the upstream and downstream pipelines 38 and 40 overlap giving rise to segments of pipeline referred to as common pipeline 42. The upstream pipeline 38 is further divided into two sections, viz., first and second upstream sections 381 and 382, wherein, the first upstream section 381 (in terms of the direction of the fluid flow) proceeds from the a third opening of the reservoir manifold 22 and terminates in the pump input 16I, while the second upstream section 382 proceeds from the pump output 16O and terminates in the bladder. An electronically-controlled reservoir solenoid valve 44 is disposed on the first upstream section 381 between the reservoir manifold 22 and the pump 16 wherein, the reservoir solenoid valve 44 facilitates the fluid transfer from the reservoir 14 to the bladder. Two check valves, viz., input and output check valves 36I and 36O, are disposed right before (on the first upstream section 381) and right after the pump 16 (on the second upstream section 382) respectively so as to ensure a unidirectional flow of nitrogen.

Referring to FIGS. 1 through 3, similarly, the downstream pipeline 40 is further divided into two sections, viz., first and second downstream sections 401 and 402, wherein, the first downstream section 401 (in terms of the direction of the fluid flow) proceeds from the bladder and terminates in the pump input 16I through the input check valve 36I, while the second downstream section 402 proceeds from the pump output 16O and terminates in a fourth opening of the reservoir manifold 22. Notably, as mentioned earlier, the pipeline assembly further comprises a section of the pipeline (hereinafter referred to as the “first common pipeline” 421), which is common for both the upstream and downstream pipelines 38 and 40, which proceeds before the input check valve 36I and terminate after output check valve 36O.

Referring to FIGS. 1 through 3, the system 10 further comprises two solenoid-operated two-way valves 46, viz., first and second two-way valves 461 and 462, for diverting the upstream (reservoir 14 to bladder) and downstream (bladder to reservoir 14) fluid flow appropriately. As can be appreciated from the referred drawing(s), the first two-way valve 461 is where the first common pipeline 421 extending through the output check valve 36O terminates at. The two output pipelines, viz., the second upstream and downstream sections 382 and 402, extend from the first two-way valve 461 wherein, as mentioned earlier, the second upstream section 382 terminates in the bladder, while the second downstream section 402 terminates in the fourth opening of the reservoir manifold 22. The second upstream section 382, upon proceeding from the first two-way valve 461, terminates in the second two-way valve 462 whereafter, the corresponding output pipeline (which is a second common pipeline 422) terminates in the bladder. In the case of downstream fluid flow, the nitrogen flows through the second common pipeline 422 till it reaches the second two-way valve 462. Upon reaching the second two-way valve 462, the downstream nitrogen, as mentioned earlier, proceeds to flow through the rest of the downstream pipeline 40.

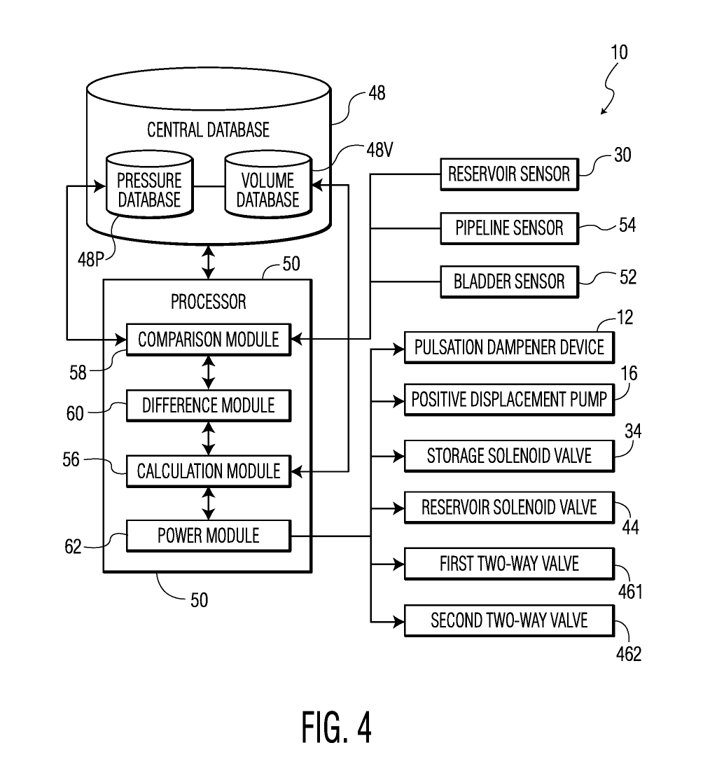

Referring to FIG. 4, the system 10 further comprises a central database 48 and a processor 50 wherein, the central database 48 is disposed in operative communication with a processor 50. The central database 48 is divided into two databases, viz., a pressure database 48P and a volume database 48V. The pressure database 48P is listed with a plurality of predetermined threshold values or threshold bracket for both preoperative and operative conditions of the pulsation dampener device 12 wherein, a threshold value or bracket comprises either a threshold pressure value or range respectively. The listed threshold values include reservoir threshold bracket, which is common for both preoperative and operative conditions of the pulsation dampener device 12, a bladder threshold, which is different for preoperative and operative conditions of the pulsation dampener device 12, a bladder threshold bracket, which is applicable only for the operative condition, and a pipeline threshold, which is applicable one for the preoperative condition of the pulsation dampener device 12. Notably, the bladder threshold at the preoperative condition is preferably 500 psi whereas, the bladder threshold at the operative condition is a value at which the volume of the bladder is half the volume of the pulsation dampener device 12. Exemplarily, the value of bladder threshold at operative condition is set to 1000 psi. Further notably, the pipeline threshold at preoperative condition preferably is zero bar. The pressure database 48P further lists a failure signature, which comprises a threshold pressure range, or a pattern of pressure readings, etc., observed in the pipeline assembly indicative of bladder failure.

Referring to FIG. 4, the volume database 48V is listed with “normal volumes” of nitrogen within the bladder and the reservoir 14 wherein, the normal value of nitrogen within the bladder is the volume of nitrogen within the bladder at a constant pressure, which preferably is 1 bar. Similarly, the normal value of nitrogen within the reservoir 14 is the volume of nitrogen within the reservoir 14 at the aforementioned constant pressure. Notably, the normal volume of nitrogen within the bladder differs that of nitrogen in the reservoir 14. The purpose of incorporating the normal value concept is to determine the volume of nitrogen that needs to be transferred between the reservoir and the storage and between the reservoir 14 and the bladder.

Referring to FIG. 4, the processor 50 comprises a calculation module 56, which is disposed in communication with the volume database 48V, for determining the volume of nitrogen to be transferred between the reservoir 14 and the storage tank 18 and between the reservoir 14 and the bladder based on the pressure reading from the bladder sensor 52, pipeline sensor 54, and the reservoir sensor 32. The processor 50 further comprises a comparison module 58, which is disposed in communication with the pressure database 48P, for comparing the pressure readings from the sensors against the corresponding threshold values thereof. The processor 50 further comprises a difference module 60, which serves between the calculation and comparison modules 56 and 58, for performing necessary mathematical functions, which will become apparent from the following body of text. The processor 50 further comprises a power module 62, which is disposed in electrical communication with the pulsation dampener device 12, bladder sensor 52, pipeline sensor 54, reservoir sensor 30, storage solenoid valve 34, reservoir solenoid valve 44, pump 16, and the first and second two-way valves 461 and 462. Notably, the central database 48 and the processor 50 are enclosed in a suitable environmental enclosure. Further, the power-related components pertaining to the sensors (low power), solenoid valves (medium pressure) and the pump (high pressure) are embodied in three separate, electrically isolated power systems.

Referring to FIGS. 1 through 4, the system 10 is configured such that, the comparison module 58 constantly compares the pressure readings from the reservoir sensor 30 against the reservoir threshold listed within the pressure database 48P. In the event of the pressure reading being below the prescribed reservoir threshold, the system 10 is configured such that, the difference module 60 calculates the difference between the current pressure within the reservoir 14 and the threshold pressure. The resultant pressure is converted into equivalent volume by the calculation module 56 based on the normal volume of nitrogen within the reservoir 14. At this point, the power module 62 transmits a computer command to open the storage solenoid valve 34 disposed on the storage pipeline 20, which results in said storage solenoid valve 34 being opened allowing the calculated volume of nitrogen in the storage tank 18 to be transferred to the reservoir 14 through the storage pipeline 20. This causes the pressure of nitrogen in the reservoir 14 to automatically reach the prescribed reservoir threshold. Notably, as the pressure of the nitrogen in the storage tank 18 is higher than that of the nitrogen in the reservoir 14, no pump 16 is needed to facilitate the transfer of nitrogen between the reservoir 14 and the storage tank 18. In the event of nitrogen not being replenished within a predetermined amount of time, the power module 62 is configured to shutdown the pulsation dampener device 12 (in the operative condition) or to prevent the pulsation dampener device 12 from being started (in the preoperative condition).

Referring to FIGS. 1 through 4, the system 10 is configured such that, at the preoperative condition of the pulsation dampener device 12, the comparison module 58 constantly compares the pressure readings from the bladder sensor 52 against the corresponding preoperative bladder threshold listed within the pressure database 48P. In the event of the pressure reading being above or below the prescribed reservoir threshold, the system 10 is configured such that, the difference module 60 calculates the difference between the current pressure within the bladder and the bladder threshold.

Referring to FIGS. 1 through 4, in the event of the current pressure being lesser than the bladder threshold, the deficient pressure is converted into equivalent volume by the calculation module 56 based on the normal volume of nitrogen within the bladder. At this point, the power module 62 transmits a computer command to open the reservoir solenoid valve 44 and another simultaneous computer command to activate the pump 16. This results in said reservoir solenoid valve 44 being opened allowing the calculated volume of nitrogen in the reservoir 14 to be pumped to the bladder through the upstream and common pipelines 38 and 42 via the pump 16 and the first and second two-way valves 461 and 462 as mentioned in the earlier body of text. Once the transfer of nitrogen from the reservoir 14 to the bladder is complete, the pressure of nitrogen within the bladder automatically reaches the prescribed bladder threshold.

Referring to FIGS. 1 through 4, in the event of the current pressure being more than the bladder threshold, the excess amount of pressure is converted into equivalent volume by the calculation module 56 based on the normal volume of nitrogen within the bladder. At this point, the power module 62 transmits a computer command to open the reservoir solenoid valve 44 and another simultaneous computer command to activate the pump 16. This results in said reservoir solenoid valve 44 being opened allowing the calculated volume of nitrogen in the bladder to be pumped to the reservoir 14 through the downstream and common pipelines 40 and 42 via the pump 16 and the first and second two-way valves 461 and 462 as mentioned in the earlier body of text. Once the transfer of nitrogen from the bladder to the reservoir 14 is complete, the pressure of nitrogen within the bladder automatically reaches the prescribed bladder threshold.

Referring to FIGS. 1 through 4, the system 10 is configured such that, during the operational condition of the pulsation dampener device 12, the comparison module 58 constantly compares the pressure readings from the bladder sensor 52 against the corresponding operative bladder threshold listed within the pressure database 48P. As mentioned earlier, the bladder threshold at operative condition of the pulsation dampener device 12 is a value at which, the volume of the bladder is half the volume of the pulsation dampener device 12. In the event of the pressure reading being above or below the prescribed reservoir threshold, the system 10 is configured such that, the difference module 60 calculates the difference between the current pressure within the bladder and the bladder threshold.

Referring to FIGS. 1 through 4, in the event of the current pressure being lesser than the bladder threshold, the deficient pressure is converted into equivalent volume by the calculation module 56 based on the normal volume of nitrogen within the bladder. At this point, the power module 62 transmits a computer command to open the reservoir solenoid valve 44 and another simultaneous computer command to activate the pump 16. This results in said reservoir solenoid valve 44 being opened allowing the calculated volume of nitrogen in the reservoir 14 to be pumped to the bladder through the upstream and common pipelines 38 and 42 via the pump 16 and the first and second two-way valves 461 and 462. Once the transfer of nitrogen from the reservoir 14 to the bladder is complete, the pressure of nitrogen within the bladder automatically reaches the prescribed bladder threshold (from the exemplary 500 psi to 1000 psi, which is 50% of the volume of the pulsation dampener device 12).

Referring to FIGS. 1 through 4, during the running of the pulsation dampener device 12, due to the increase in the intensity of the pulsation, the pipeline pressure increases causing the bladder volume to decrease below 50% of the volume of pulsation dampener device 12. On the other hand, as the operation of the pulsation dampener device 12 nears a close, the pulsation pressure in the pipeline assembly decreases causing the bladder to expand beyond 50% of the volume of the pulsation dampener device 12.

Referring to FIGS. 1 through 4, in the event of the current pressure being lesser than the bladder threshold bracket, the deficient amount of pressure is converted into equivalent volume by the calculation module 56 based on the normal volume of nitrogen within the bladder. At this point, the power module 62 transmits a computer command to open the reservoir solenoid valve 44 and another simultaneous computer command to activate the pump 16. This results in said reservoir solenoid valve 44 being opened allowing the calculated volume of nitrogen in the reservoir 14 to be pumped to the bladder through the upstream and common pipelines 38 and 42 via the first and second two-way valves 461 and 462. Once the transfer of nitrogen from the bladder to the reservoir 14 is complete, the pressure of nitrogen within the bladder automatically falls within the bladder threshold bracket.

Referring to FIGS. 1 through 4, in the event of the current pressure being greater than the bladder threshold bracket, the excess amount of pressure is converted into equivalent volume by the calculation module 56 based on the normal volume of nitrogen within the bladder. At this point, the power module 62 transmits a computer command to open the reservoir solenoid valve 44 and another simultaneous computer command to activate the pump 16. This results in said reservoir solenoid valve 44 being opened allowing the calculated volume of nitrogen in the bladder to be pumped to the reservoir 14 through the downstream and common pipelines 40 and 42 via the first and second two-way valves 461 and 462. Once the transfer of nitrogen from the reservoir 14 to the bladder is complete, the pressure of nitrogen within the bladder automatically falls within the bladder threshold bracket. Notably, the purpose of incorporating the concept of bladder threshold bracket is to engage in trend monitoring, which controls overcorrection by preventing a high number of smaller amounts of adjustments.

Referring to FIGS. 1 through 4, the system 10 is configured such that, the comparison module 58 constantly compares the pressure readings from the pipeline sensor 54 against the pipeline threshold (zero bar) listed within the pressure database 48P. In the preoperative condition, in the event of the fluid pressure within the pipeline assembly reading being positive, the system 10 is configured such that, the power module 62 transmits a computer command to open the reservoir solenoid valve 44, which results in said reservoir solenoid valve 44 being opened allowing nitrogen in the pipeline assembly to be transferred to either reservoir 14 or the bladder. The system 10 is configured such that, the pulsation dampener device 12 doesn't start until the pressure within the pipeline assembly is at the pipeline threshold.

Referring to FIGS. 1 through 4, the system 10 is configured such that, in the operative condition of the pulsation dampener device 12, in the event of the pressure readings from the pipeline sensor 54 during the downstream flow of nitrogen satisfying a predetermined failure signature, the power module 62 is configured to immediately shutdown the operations of the devices associated thereto including the pump 16 and the pulsation dampener device 12. The failure signature may comprise either one or more consecutive pressure readings being above or below a predetermined pressure threshold or a predetermined pattern of pressure readings.

Referring to FIGS. 1 through 3, an embodiment of the present invention comprises a pulsation dampener control method for controlling the operations of a pulsation dampener device 12. The method involves providing a nitrogen reservoir 14, a positive displacement pump 16, and a nitrogen storage tank 18. The method of the present invention optimizes the operational effectiveness of the pulsation dampener device 12, while increasing the longevity and reliability of the bladder of the pulsation dampener device 12 and decreasing the risks to the health and safety of the environment.

Referring to FIGS. 1 through 3, the method of the present invention further involves providing a storage pipeline 20 extending between the reservoir 14 and the storage tank 18 for facilitating fluid transfer therebetween. More particularly, sections of storage pipeline 20 proceeding from the reservoir 14 and the storage tank 18 terminate in a reservoir manifold 22 and a storage manifold 24 respectively, while the rest of the storage pipeline 20 extends between first openings of the reservoir and storage manifolds 22 and 24. Notably, two manual valves, viz., a reservoir manual valve 26 and a storage manual valve 28, are disposed on the storage pipeline 20 between the reservoir 14 and the reservoir manifold 22 and between the storage tank 18 and the storage manifold 24 respectively for manually permitting or blocking the fluid flow from the reservoir 14 and storage tank 18 respectively in the event of an emergency, or the like. A reservoir sensor 30 and a storage sensor 32 extend from a second opening of each of the reservoir and storage manifolds 22 and 24 respectively so as to constantly gauge the pressure of nitrogen in both of the reservoir and storage tank 14 and 18 in real time. An electronically-controlled storage solenoid valve 34 is disposed on the storage pipeline 20 extending between the reservoir and storage manifolds 22 and 24 wherein, the storage solenoid valve 34 facilitates fluid transfer from the storage tank 18 and the reservoir 14. Further, a check valve 36 is disposed between the storage solenoid valve 34 and the storage manifold 24 so as to ensure a unidirectional flow of nitrogen from the storage tank 18 to the reservoir 14. Notably, as the pressure of the nitrogen in the storage tank 18 is always higher than that of the nitrogen in the reservoir 14, no pump is needed to facilitate the transfer of nitrogen therebetween.

Referring to FIGS. 1 through 3, the method further involves providing a pipeline assembly extending between the reservoir 14 and the bladder so as to enable the fluid transfer therebetween. The pipeline assembly comprises an upstream and a downstream pipeline 38 and 40 wherein, the upstream pipeline 38 enables the flow of nitrogen from the reservoir 14 to the bladder and whereas, the downstream pipeline 40 enables the flow of nitrogen from the bladder to the reservoir 14. Notably, in the pipeline assembly, the upstream and downstream pipelines 38 and 40 overlap giving rise to segments of pipeline referred to as common pipeline 42. The upstream pipeline 38 is further divided into two sections, viz., first and second upstream sections 381 and 382, wherein, the first upstream section 381 (in terms of the direction of the fluid flow) proceeds from the a third opening of the reservoir manifold 22 and terminates in the pump input 16I, while the second upstream section 382 proceeds from the pump output 16O and terminates in the bladder. An electronically-controlled reservoir solenoid valve 44 is disposed on the first upstream section 381 between the reservoir manifold 22 and the pump 16 wherein, the reservoir solenoid valve 44 facilitates the fluid transfer from the reservoir 14 to the bladder. Two check valves, viz., input and output check valves 36I and 36O, are disposed right before (on the first upstream section 381) and right after the pump 16 (on the second upstream section 382) respectively so as to ensure a unidirectional flow of nitrogen.

Referring to FIGS. 1 through 3, similarly, the downstream pipeline 40 is further divided into two sections, viz., first and second downstream sections 401 and 402, wherein, the first downstream section 401 (in terms of the direction of the fluid flow) proceeds from the bladder and terminates in the pump input 16I through the input check valve 36I, while the second downstream section 402 proceeds from the pump output 16O and terminates in a fourth opening of the reservoir manifold 22. Notably, as mentioned earlier, the pipeline assembly further comprises a section of the pipeline (hereinafter referred to as the “first common pipeline” 421), which is common for both the upstream and downstream pipelines 38 and 40, which proceeds before the input check valve 36I and terminate after output check valve 36O.

Referring to FIGS. 1 through 3, the method further involves providing two solenoid-operated two-way valves 46, viz., first and second two-way valves 461 and 462, for diverting the upstream (reservoir 14 to bladder) and downstream (bladder to reservoir 14) fluid flow appropriately. As can be appreciated from the referred drawing(s), the first two-way valve 461 is where the first common pipeline 421 extending through the output check valve 36O terminates at. The two output pipelines, viz., the second upstream and downstream sections 382 and 402, extend from the first two-way valve 461 wherein, as mentioned earlier, the second upstream section 382 terminates in the bladder, while the second downstream section 402 terminates in the fourth opening of the reservoir manifold 22. The second upstream section 382, upon proceeding from the first two-way valve 461, terminates in the second two-way valve 462 whereafter, the corresponding output pipeline (which is a second common pipeline 422) terminates in the bladder. In the case of downstream fluid flow, the nitrogen flows through the second common pipeline 422 till it reaches the second two-way valve 462. Upon reaching the second two-way valve 462, the downstream nitrogen, as mentioned earlier, proceeds to flow through the rest of the downstream pipeline 40.

Referring to FIG. 4, the method further involves providing a central database 48 and a processor 50 wherein, the central database 48 is disposed in operative communication with a processor 50. The central database 48 is divided into two databases, viz., a pressure database 48P and a volume database 48V. The pressure database 48P is listed with a plurality of predetermined threshold values for both preoperative and operative conditions of the pulsation dampener device 12 wherein, a threshold value comprises a threshold pressure value. The listed threshold values include reservoir threshold, which is common for both preoperative and operative conditions of the pulsation dampener device 12, a bladder threshold, which is different for preoperative and operative conditions of the pulsation dampener device 12, a bladder threshold bracket, which comprises a threshold pressure range applicable only for the operative condition, and a pipeline threshold, which is applicable one for the preoperative condition of the pulsation dampener device 12. Notably, the bladder threshold at the preoperative condition is preferably 500 psi whereas, the bladder threshold at the operative condition is a value at which the volume of the bladder is half the volume of the pulsation dampener device 12. Exemplarily, the value of bladder threshold at operative condition is set to 1000 psi. Further notably, the pipeline threshold at preoperative condition preferably is zero bar. The pressure database 48P further lists a failure signature, which comprises a threshold pressure range, or a pattern of pressure readings, etc., observed in the pipeline assembly indicative of bladder failure.

Referring to FIG. 4, the volume database 48V is listed with “normal volumes” of nitrogen within the bladder and the reservoir 14 wherein, the normal value of nitrogen within the bladder is the volume of nitrogen within the bladder at a constant pressure, which preferably is 1 bar. Similarly, the normal value of nitrogen within the reservoir 14 is the volume of nitrogen within the reservoir 14 at the aforementioned constant pressure. Notably, the normal volume of nitrogen within the bladder differs that of nitrogen in the reservoir 14. The purpose of incorporating the normal value concept is to determine the volume of nitrogen that needs to be transferred between the reservoir and the storage and between the reservoir 14 and the bladder.

Referring to FIG. 4, the processor 50 comprises a calculation module 56, which is disposed in communication with the volume database 48V, for determining the volume of nitrogen to be transferred between the reservoir 14 and the storage tank 18 and between the reservoir 14 and the bladder based on the pressure reading from the bladder sensor 52, pipeline sensor 54, and the reservoir sensor 32. The processor 50 further comprises a comparison module 58, which is disposed in communication with the pressure database 48P, for comparing the pressure readings from the sensors against the corresponding threshold values thereof. The processor 50 further comprises a difference module 60, which serves between the calculation and comparison modules 56 and 58, for performing necessary mathematical functions, which will become apparent from the following body of text. The processor 50 further comprises a power module 62, which is disposed in electrical communication with the pulsation dampener device 12, bladder sensor 52, pipeline sensor 54, reservoir sensor 30, storage solenoid valve 34, reservoir solenoid valve 44, pump 16, and the first and second two-way valves 461 and 462. Notably, the central database 48 and the processor 50 are enclosed in a NEMA4 rated enclosure. Further, the power-related components pertaining to the sensors (low power), solenoid valves (medium pressure) and the pump (high pressure) are embodied in three separate, electrically isolated power systems.

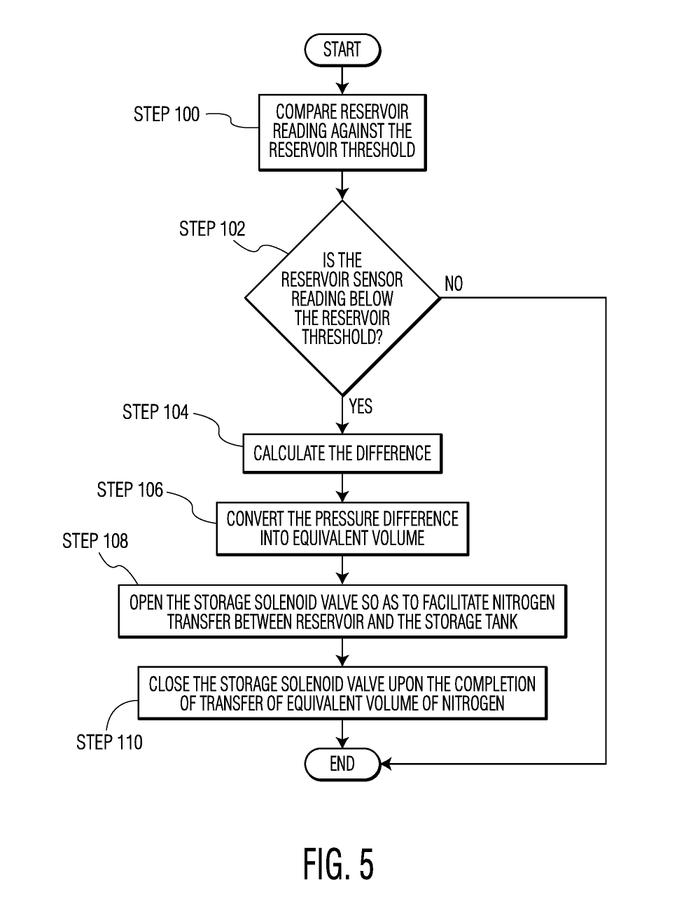

Referring to FIGS. 1 through 5, the method includes constantly comparing (step 100), as enabled by the comparison module 58, the pressure readings from the reservoir sensor 30 against the reservoir threshold listed within the pressure database 48P. In the event of the pressure reading being below the prescribed reservoir threshold, the method includes calculating (step 104), as enabled by the difference module 60, the difference between the current pressure within the reservoir 14 and the threshold pressure. The method further includes converting (step 106), as enabled by the calculation module 56, the resultant pressure into equivalent volume based on the normal volume of nitrogen within the reservoir 14. Upon determining the equivalent volume, the method further includes, transmitting, as enabled by the power module 62, to open (step 108) the storage solenoid valve 34 disposed on the storage pipeline 20 resulting in allowing the calculated volume of nitrogen in the storage tank 18 to be transferred to the reservoir 14 through the storage pipeline 20. This causes the pressure of nitrogen in the reservoir 14 to automatically reach the prescribed reservoir threshold, at which point, the storage solenoid valve 34 is configured to be automatically closed (step 110). Notably, as the pressure of the nitrogen in the storage tank 18 is higher than that of the nitrogen in the reservoir 14, no pump 16 is needed to facilitate the transfer of nitrogen between the reservoir 14 and the storage tank 18. In the event of nitrogen not being replenished within a predetermined amount of time, the method includes shutting down, as enabled by the power module 62, the pulsation dampener device 12 (in the operative condition) or preventing the pulsation dampener device 12 from being started (in the preoperative condition).

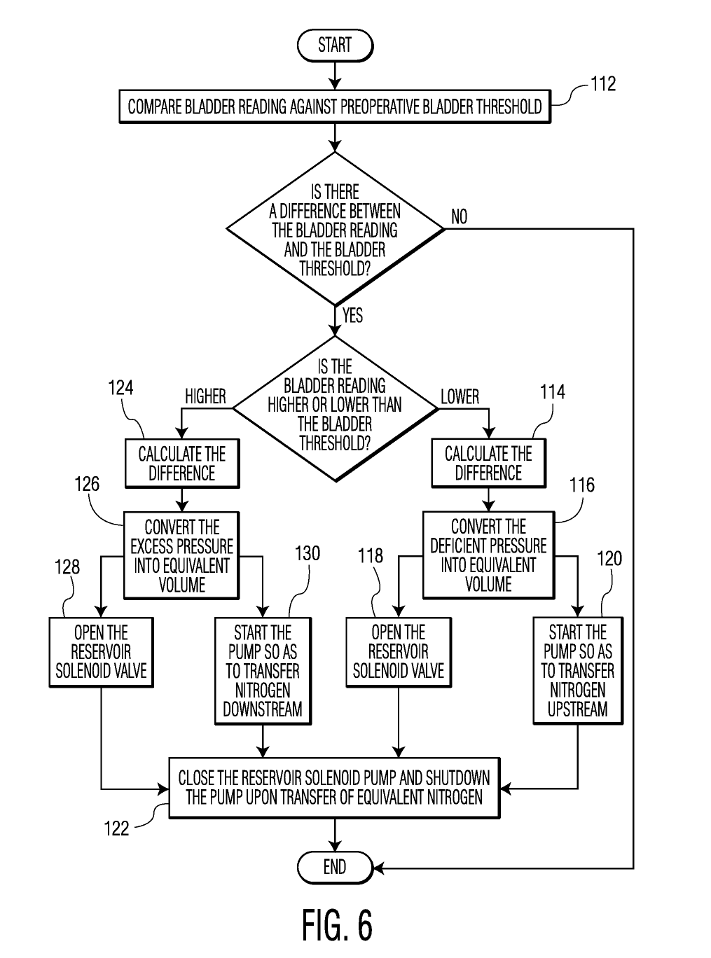

Referring to FIGS. 1 through 4, and 6, the method further includes, at the preoperative condition of the pulsation dampener device 12, constantly comparing (step 112), as enabled by the comparison module 58, the pressure readings from the bladder sensor 52 against the corresponding preoperative bladder threshold listed within the pressure database 48P. The method further includes, in the event of the pressure reading being above or below the prescribed reservoir threshold, calculating (steps 114, 124), as enabled by the difference module 60, the difference between the current pressure within the bladder and the bladder threshold.

Referring to FIGS. 1 through 4, and 6, the method further includes, in the event of the current pressure being lesser than the bladder threshold, converting (step 116), as enabled by the calculation module 56 based on the normal volume of nitrogen within the bladder, the deficient pressure into equivalent volume. Upon obtaining the equivalent volume, the method further includes, transmitting, as enabled by the power module 62, a computer command to open (step 118) the reservoir solenoid valve 44 and another simultaneous computer command to activate (step 120) the pump 16. This results in said reservoir solenoid valve 44 being opened allowing the calculated volume of nitrogen in the reservoir 14 to be pumped to the bladder through the upstream and common pipelines 38 and 42 via the pump 16 and via the first and second two-way valves 461 and 462 as mentioned in the earlier body of text. The method further includes, closing (step 122) the reservoir solenoid valve 44 and shutting down the pump once the transfer of nitrogen from the reservoir 14 to the bladder is complete. Notably, once the transfer of nitrogen is complete, the pressure of nitrogen within the bladder automatically reaches the prescribed bladder threshold.

Referring to FIGS. 1 through 4, and 6, the method further includes, in the event of the current pressure being more than the bladder threshold, converting (step 126), as enabled by the calculation module 56 based on the normal volume of nitrogen within the bladder, the excess amount of pressure into equivalent volume. Upon obtaining equivalent volume, the method further includes transmitting, as enabled by the power module 62, a computer command to open (step 128) the reservoir solenoid valve 44 and another simultaneous computer command to activate (step 130) the pump 16. This results in said reservoir solenoid valve 44 being opened allowing the calculated volume of nitrogen in the bladder to be pumped to the reservoir 14 through the downstream and common pipelines 40 and 42 via the pump 16 and the first and second two-way valves 461 and 462 as mentioned in the earlier body of text. The method further includes, closing (step 122), as enabled by the power module 62, once the transfer of nitrogen from the bladder to the reservoir 14 is complete. Notably, once the transfer of nitrogen from the bladder to the reservoir 14 is complete, the pressure of nitrogen within the bladder automatically reaches the prescribed bladder threshold.

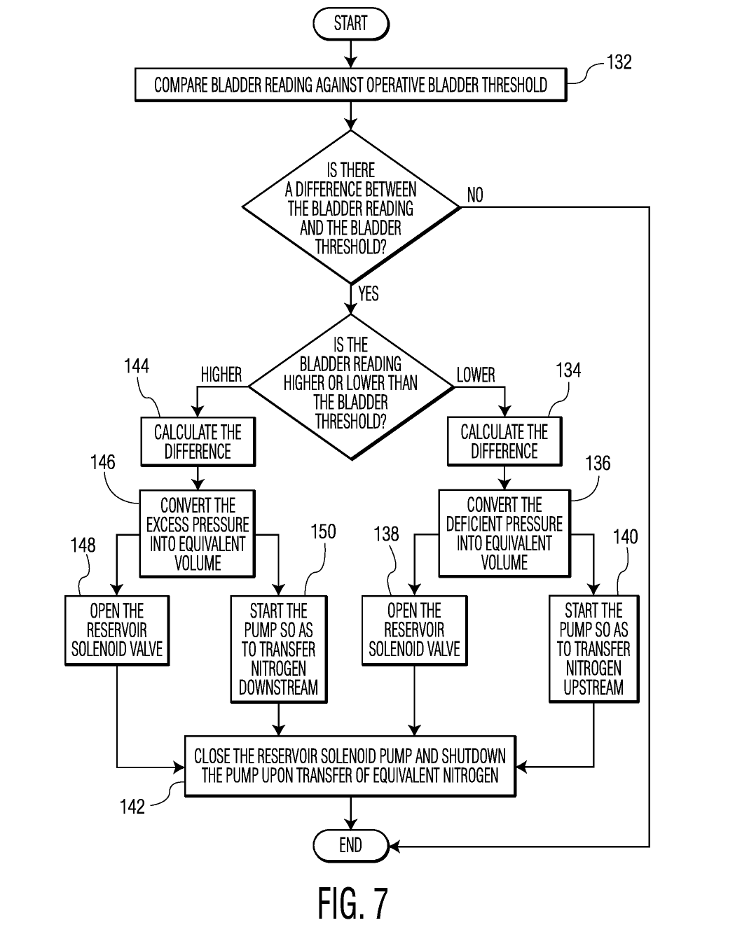

Referring to FIGS. 1 through 4, and 7, the method further includes, during the operational condition of the pulsation dampener device 12, comparing (step 132), as enabled by the comparison module 58, the pressure readings from the bladder sensor 52 against the corresponding operative bladder threshold listed within the pressure database 48P. As mentioned earlier, the bladder threshold at operative condition of the pulsation dampener device 12 is a value at which, the volume of the bladder is half the volume of the pulsation dampener device 12. The method further includes, in the event of the pressure reading being above or below the prescribed reservoir threshold, calculating (steps 134, 144), as enabled by the difference module 60, the difference between the current pressure within the bladder and the bladder threshold.

Referring to FIGS. 1 through 4, and 7, the method further includes, in the event of the current pressure being lesser than the bladder threshold, converting (step 136), as enabled by the calculation module 56, the deficient pressure into equivalent volume based on the normal volume of nitrogen within the bladder. The method further includes, transmitting, as enabled by the power module 62, a computer command to open (step 138) the reservoir solenoid valve 44 and another simultaneous computer command to activate (step 140) the pump 16. This results in said reservoir solenoid valve 44 being opened allowing the calculated volume of nitrogen in the reservoir 14 to be pumped to the bladder through the upstream and common pipelines 38 and 42 via the pump 16 and the first and second two-way valves 461 and 462. The method further includes closing (step 142), as enabled by the power module 62, the reservoir solenoid valve 44 and shutting down the pump 16 once the transfer of nitrogen from the reservoir 14 to the bladder is complete. Notably, once the transfer of nitrogen in complete, the pressure of nitrogen within the bladder automatically reaches the prescribed bladder threshold (from the exemplary 500 psi to 1000 psi, which is 50% of the volume of the pulsation dampener device 12).

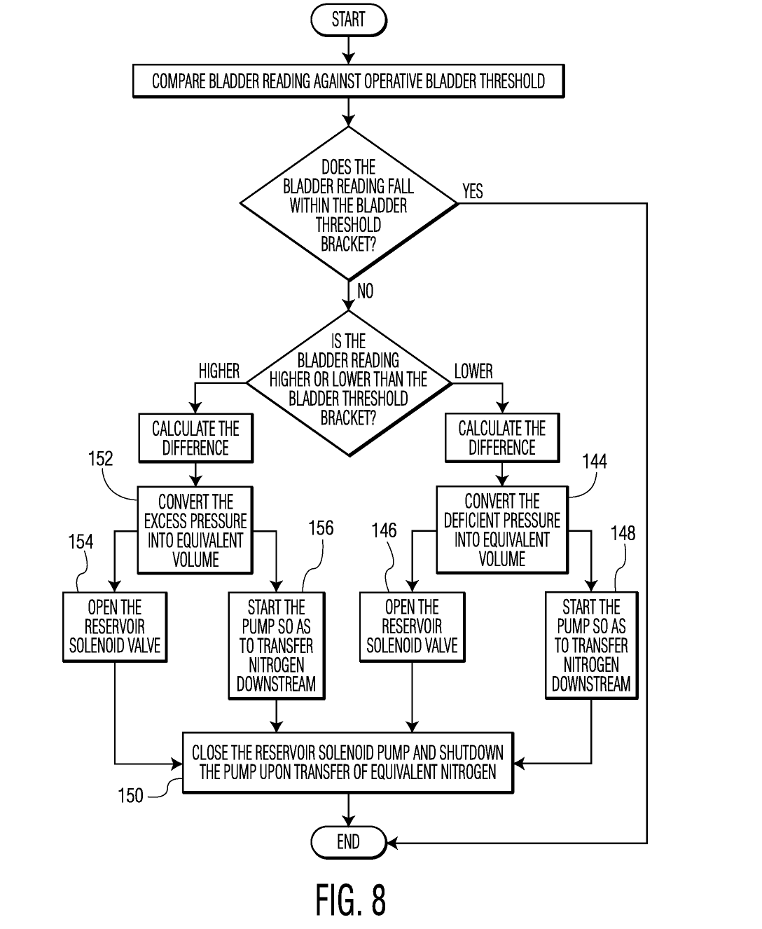

Referring to FIGS. 1 through 4, and 8, during the running of the pulsation dampener device 12, due to the increase in the intensity of the pulsation, the pipeline pressure increases causing the bladder volume to decrease below 50% of the volume of pulsation dampener device 12. On the other hand, as the operation of the pulsation dampener device 12 nears a close, the pulsation pressure in the pipeline assembly decreases causing the bladder to expand beyond 50% of the volume of the pulsation dampener device 12.

Referring to FIGS. 1 through 4, and 8, the method further includes, in the event of the current pressure being lesser than the bladder threshold bracket, converting (step 144), as enabled by the calculation module 56 based on the normal volume of nitrogen within the bladder, the deficient amount of pressure is into equivalent volume. The method further includes, transmitting, as enabled by the power module 62, a computer command to open (step 146) the reservoir solenoid valve 44 and another simultaneous computer command to activate (step 148) the pump 16. This results in said reservoir solenoid valve 44 being opened allowing the calculated volume of nitrogen in the reservoir 14 to be pumped to the bladder through the upstream and common pipelines 38 and 42 via the first and second two-way valves 461 and 462. The method further includes closing (step 150) reservoir solenoid valve 44 and shutting down the pump 16 once the transfer of nitrogen from the bladder to the reservoir 14 is complete. Notably, once the transfer of nitrogen is complete, the pressure of nitrogen within the bladder automatically falls within the bladder threshold bracket.

Referring to FIGS. 1 through 4, and 8, the method further includes, in the event of the current pressure being greater than the bladder threshold bracket, converting (step 152), as enabled by the calculation module 56 based on the normal volume of nitrogen within the bladder, the excess amount of pressure is into equivalent volume. The method further includes, transmitting, as enabled by the power module 62, a computer command to open (step 154) the reservoir solenoid valve 44 and another simultaneous computer command to activate (step 156) the pump 16. This results in said reservoir solenoid valve 44 being opened allowing the calculated volume of nitrogen in the bladder to be pumped to the reservoir 14 through the downstream and common pipelines 38 and 42 via the first and second two-way valves 461 and 462. The method further includes closing reservoir solenoid valve 44 and shutting down the pump 16 once the transfer of nitrogen is complete. Notably, once the transfer of nitrogen is complete, the pressure of nitrogen within the bladder automatically falls within the bladder threshold bracket. Notably, the purpose of incorporating the concept of bladder threshold bracket is to engage in trend monitoring, which controls overcorrection by preventing a high number of smaller amounts of adjustments.

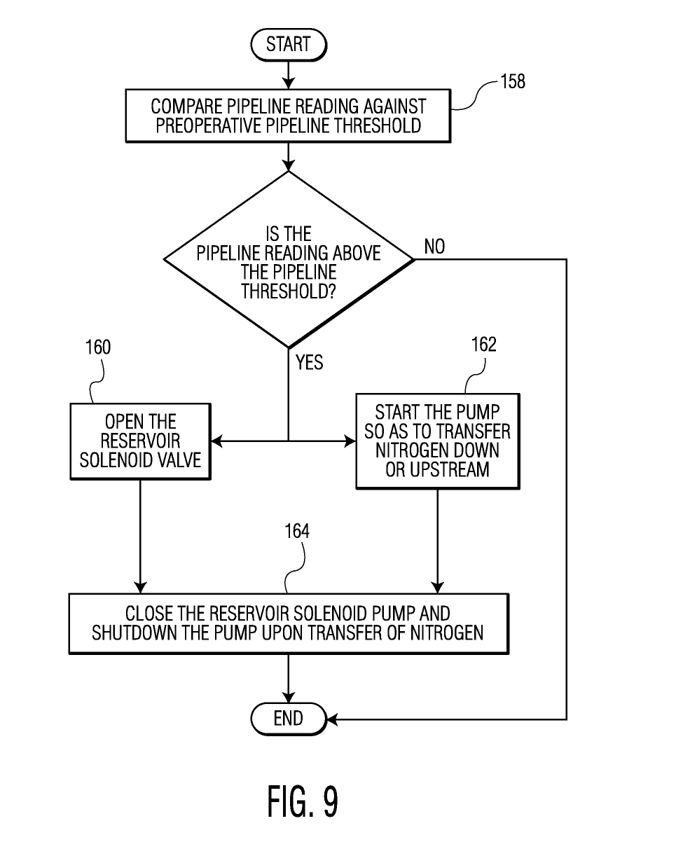

Referring to FIGS. 1 through 4, and 9, the method further includes, comparing (step 158), as enabled by the comparison module 58, pressure readings from the pipeline sensor 54 against the pipeline threshold (zero bar) listed within the pressure database 48P. The method further includes, in the preoperative condition of the pulsation dampener device 12 and in the event of the fluid pressure within the pipeline assembly reading being positive, transmitting, as enabled by the power module 62, a computer command to open (step 16O) the reservoir solenoid valve 44, which results in said reservoir solenoid valve 44 being opened allowing nitrogen in the pipeline assembly to be transferred to either reservoir 14 or the bladder. The pump 16 may also be activated (162) so as pump nitrogen in the pipeline assembly to be transferred. The system 10 is configured such that, the pulsation dampener device 12 doesn't start until the pressure within the pipeline assembly is at the pipeline threshold.

Referring to FIGS. 1 through 4, the method further includes, in the operative condition of the pulsation dampener device 12 and in the event of the pressure readings from the pipeline sensor 54 during the downstream flow of nitrogen satisfying a predetermined failure signature, shutting down, as enabled by the power module 62, the operations of system 10 including the pump 16, the pulsation dampener device 12, and other associated devices if any. The failure signature may comprise either one or more consecutive pressure readings being above or below a predetermined pressure threshold or a predetermined pattern of pressure readings.

The aforementioned embodiments are able to be implemented, for example, using a machine-readable medium or article which is able to store an instruction or a set of instructions that, if executed by a machine, cause the machine to perform a method and/or operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software. The machine-readable medium or article is able to include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions is able to include any suitable type of code, for example, source code, compiled code, interpreted code, executable code, static code, dynamic code, or the like, and is able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A pulsation dampener control system comprising:
(a) a pulsation dampener device;
(b) a fluid reservoir;
(c) a pump comprising an input and an output;
(d) a pipeline assembly extending between the reservoir and the bladder of the pulsation dampener device, the pipeline assembly comprising:
(i) an upstream pipeline comprising pipeline for carrying fluid from the reservoir to the bladder; and
(ii) a downstream pipeline comprising pipeline for carrying fluid from the bladder to reservoir; and
(e) a bladder sensor for gauging the fluid pressure within the bladder;
wherein, the system is configured such that, during the preoperative condition of the pulsation dampener device, when the pressure of the fluid within the bladder is above or below a predetermined preoperative bladder threshold, the excess or deficient equivalent volume of fluid respectively is transferred from the bladder to the reservoir or from the reservoir to the bladder respectively through the downstream or upstream pipelines respectively as enabled by the pump and wherein, the system is configured such that, during the operative condition of the pulsation dampener device, a pressure reading of the fluid within the bladder is above or below a predetermined operative bladder threshold, the excess or deficient equivalent volume of fluid respectively is transferred from the bladder to the reservoir or from the reservoir to the bladder respectively through the downstream or upstream pipelines respectively as enabled by the pump.

2. The system of claim 1 wherein, the pipeline assembly further comprises one or more common pipelines; a common pipeline comprising a section of pipeline pertaining to the pipeline assembly, which is common to both the upstream and downstream pipelines.

3. The system of claim 2 wherein, the pump is disposed on a first common pipeline.

4. The system of claim 3 wherein, a pair of check valves are disposed on the input and output sides of the pump, the check valves disposed on first common pipeline, the check valves ensuring a unidirectional fluid flow within the pipeline assembly.

5. The system of claim 1 wherein, a reservoir solenoid valve is disposed on the upstream pipeline between the reservoir and the pump, the reservoir solenoid valve for permitting fluid flow between the bladder and the reservoir.

6. The system of claim 1 wherein, the pump comprises a positive displacement pump.

7. The system of claim 1 wherein, the fluid comprises nitrogen.

8. The system of claim 1 further comprising at least one pipeline sensor for gauging the fluid pressure in the pipeline assembly.

9. The system of claim 8 wherein, the system is configured such that, when at least one pressure reading from each of the at least one pipeline sensor satisfy a predetermined failure signature, the pump and the pulsation dampener device are shutdown; the failure signature may comprise either one or more consecutive pressure readings being above or below a predetermined pressure value or a pattern of pressure readings, which indicative of bladder failure.

10. The system of claim 9 wherein, the at least one pressure reading comprises a plurality of pressure readings.

11. The system of claim 9 configured such that, the pulsation dampener device is rendered inoperative in the event of the pressure in the pipeline assembly being above a predetermined pipeline threshold.

12. The system of claim 1 further comprising a manual valve disposed on a third common pipeline extending from the reservoir; the manual valve for manually obstructing or permitting fluid transfer between the bladder and the reservoir.

13. The system of claim 1 further comprising:
(a) a fluid storage tank;
(b) a storage pipeline extending between the storage tank and the reservoir; and
(c) a pressure sensor for gauging the pressure within the reservoir;
wherein, the system is configured such that, when the pulsation dampener device is not operative and when the pressure of the fluid within the reservoir is above or below a predetermined reservoir threshold, the excess or deficient equivalent volume of fluid respectively is transferred from the reservoir to the storage tank or from the storage tank to the reservoir respectively.

14. The system of claim 13 configured such that, the pulsation dampener device ceases to operative in the event of the fluid pressure in the storage tank is below the reservoir threshold.

15. The system of claim 1 further comprising:
(a) a central database, which further comprises
(i) a pressure database comprising pressure thresholds in preoperative and operative conditions of the pulsation dampener device wherein, the pressure thresholds in the preoperative condition comprises:
(1) a reservoir threshold comprising a pressure threshold or a pressure threshold range the reservoir needs to satisfy prior to the operation of the pulsation dampener device;
(2) a dampener threshold comprising a pressure threshold or a pressure threshold range the dampener needs to satisfy prior to the operation of the pulsation dampener device; and
(3) a pipeline threshold comprising a pressure threshold the pipeline needs to satisfy prior to the operation of the pulsation dampener device; and
wherein, the pressure threshold in the operative condition comprises a dampener threshold comprising a pressure threshold or a pressure threshold range the dampener needs to satisfy prior to the operation of the pulsation dampener device; and
(ii) a volume database comprising:
(1) the normal volume of fluid within the bladder, which comprises a the volume occupied by the fluid within the bladder at a predetermined constant pressure; and
(2) the normal volume of fluid within the reservoir, which comprises a the volume occupied by the fluid within the reservoir at a predetermined constant pressure;
(b) a processor comprising
(i) a comparison module for comparing, in preoperative and operative conditions of the pulsation dampener device, the current pressure reading of the reservoir, pipeline, and the bladder against the respective thresholds;
(ii) a difference module for determining the difference in pressure in the event of the current pressure readings being above or below the respective thresholds;
(iii) a calculation module for calculating the equivalent fluid volume based on the difference; and
(iv) a power module for controlling the pulsation dampener device and the pump accordingly.

16. The system of claim 15 wherein, the predetermined pipeline threshold is zero bar.

17. The system of claim 1 further comprising a calculation module for calculating the volume of fluid in the bladder based on the pressure gauged by the bladder sensor.

18. The system of claim 1 wherein, the predetermined operative bladder threshold is the pressure at which, the volume of the bladder is at substantially the midpoint of the volume of the pulsation dampener device.

19. A pulsation dampener control method comprising:
(a) providing a pulsation dampener device;
(b) providing a fluid reservoir;
(c) providing pump comprising an input and an output;
(d) providing a pipeline assembly extending between the reservoir and the bladder of the pulsation dampener device, the pipeline assembly comprising:
(i) an upstream pipeline comprising pipeline for carrying fluid from the reservoir to the bladder; and
(ii) a downstream pipeline comprising pipeline for carrying fluid from the bladder to reservoir; and
(e) gauging the fluid pressure within the bladder;
wherein, during the preoperative condition of the pulsation dampener device and when the pressure of the fluid within the bladder is above or below a predetermined preoperative bladder threshold, the excess or deficient equivalent volume of fluid respectively is transferred from the bladder to the reservoir or from the reservoir to the bladder respectively through the downstream or upstream pipelines respectively as enabled by the pump and wherein, during the operative condition of the pulsation dampener device and when a pressure reading of the fluid within the bladder is above or below a predetermined operative bladder threshold, the excess or deficient equivalent volume of fluid respectively is transferred from the bladder to the reservoir or from the reservoir to the bladder respectively through the downstream or upstream pipelines respectively as enabled by the pump.

20. The method of claim 19 wherein, the pipeline assembly further comprises one or more common pipelines; a common pipeline comprising a section of pipeline pertaining to the pipeline assembly, which is common to both the upstream and downstream pipelines.

21. The method of claim 20 wherein, the pump is disposed on a first common pipeline.

22. The method of claim 21 further comprising providing a pair of check valves are disposed on the input and output sides of the pump, the check valves disposed on first common pipeline, the check valves ensuring a unidirectional fluid flow within the pipeline assembly.

23. The method of claim 19 further comprising providing a reservoir solenoid valve is disposed on the upstream pipeline between the reservoir and the pump, the reservoir solenoid valve for permitting fluid flow between the bladder and the reservoir.

24. The method of claim 19 wherein, the pump comprises a positive displacement pump.

25. The method of claim 19 wherein, the fluid comprises nitrogen.

26. The method of claim 19 further comprising providing a pipeline sensor for gauging the fluid pressure in the pipeline assembly.

27. The method of claim 26 further comprising shutting down the pump and the pulsation dampener device in the event of a pressure reading from the pipeline sensor satisfy a predetermined failure signature; the failure signature may comprise either one or more consecutive pressure readings being above or below a predetermined pressure value or a pattern of pressure readings, which indicative of bladder failure.

28. The method of claim 27 wherein, the at least one pressure reading comprises a plurality of pressure readings.

29. The method of claim 27 further comprising rendering the pulsation dampener device inoperative in the event of the pressure in the pipeline assembly being above a predetermined pipeline threshold.

30. The method of claim 19 further comprising providing a manual valve disposed on a third common pipeline extending from the reservoir; the manual valve for manually obstructing or permitting fluid transfer between the bladder and the reservoir.

31. The method of claim 1 further comprising:
(a) providing a fluid storage tank;
(b) providing a storage pipeline extending between the storage tank and the reservoir; and
(c) gauging the fluid pressure within the reservoir;
wherein, when the pulsation dampener device is not operative and when the pressure of the fluid within the reservoir is above or below a predetermined reservoir threshold, the excess or deficient equivalent volume of fluid respectively is transferred from the reservoir to the storage tank or from the storage tank to the reservoir respectively.

32. The method of claim 13 wherein, the pulsation dampener device ceases to operative in the event of the fluid pressure in the storage tank is below the reservoir threshold.

33. The method of claim 1 further comprising:
(a) a central database, which further comprises
(i) listing a plurality of pressure threshold within a pressure database, the pressure thresholds pertaining to both preoperative and operative conditions of the pulsation dampener device, wherein, the pressure thresholds in the preoperative condition comprises:
(1) a reservoir threshold comprising a pressure threshold or a pressure threshold range the reservoir needs to satisfy prior to the operation of the pulsation dampener device;
(2) a dampener threshold comprising a pressure threshold or a pressure threshold range the dampener needs to satisfy prior to the operation of the pulsation dampener device; and
(3) a pipeline threshold comprising a pressure threshold the pipeline needs to satisfy prior to the operation of the pulsation dampener device; and
wherein, the pressure threshold in the operative condition comprises a dampener threshold comprising a pressure threshold or a pressure threshold range the dampener needs to satisfy prior to the operation of the pulsation dampener device; and
(ii) listing within a volume database:
(1) normal volume of fluid within the bladder, which comprises a the volume occupied by the fluid within the bladder at a predetermined constant pressure; and
(2) normal volume of fluid within the reservoir, which comprises a the volume occupied by the fluid within the reservoir at a predetermined constant pressure;
(b) providing a processor for:
(i) comparing, in preoperative and operative conditions of the pulsation dampener device, the current pressure reading of the reservoir, pipeline, and the bladder against the respective thresholds;
(ii) determining the difference in pressure in the event of the current pressure readings being above or below the respective thresholds;
(iii) calculating the equivalent fluid volume based on the difference; and
(iv) controlling the pulsation dampener device and the pump accordingly.

34. The method of claim 33 wherein, the predetermined pipeline threshold is zero bar.

35. The method of claim 1 wherein, the predetermined operative bladder threshold is the pressure at which, the volume of the bladder is at substantially the midpoint of the volume of the pulsation dampener device.
